(19) United States
(12) Patent Application Publication
(10) Pub. No.: US 2008/0142317 A1
(43) Pub. Date: Jun. 19, 2008

(54) Spindle

(76) Inventors: Uwe Probst, Orsingen-Nenzingen (DE); Bernhard Markus, Orsingen-Nenzingen (DE); Dietmar Konig, Titisee-Neustadt (DE); Markus Kummel, Donaueschingen (DE); Stephan Roos, Wertheim/Hohefeld (DE)

Correspondence Address: NATH & ASSOCIATES, 112 South West Street, Alexandria, VA, 22314, US

(21) Appl. No.: 11/667,560

(22) PCT Filed: Sep. 10, 2005
(86) PCT No.: PCT/EP05/09753

§ 371 Date: Nov. 5, 2007

(30) Foreign Application Priority Data
Nov. 12, 2004 (DE) 10 2004 054 864.1

(51) Int. Cl. B60T 17/00; B60T 11/04; F16C 1/16; B21D 39/00

(52) U.S. Cl. 188/156; 29/505; 403/345

(57) ABSTRACT

The invention relates to a spindle (1), in particular an electromechanical parking brake of a vehicle, which is embodied as a component of a spindle drive. The aim of the invention is to secure, in a detachable and simple manner, a standard cable pull comprising fittings to a spindle. Said aim is achieved in that a coupling part (7) comprising a receiving section (8) which is used to receive a fitting (9) of the cable pull (6) and a securing section (10) is provided on one free end section (11) of the spindle (1). The securing section (10) of the coupling part (7) are crimped to the free end section (11) of the spindle (1). The invention also relates to a connecting method.

The invention relates to a spindle, specifically as component of the spindle drive of an electromechanical parking brake in an automobile. It also relates to a connecting process, specifically for connecting a coupling part to a spindle.

An electromechanical parking brake replaces the classical hand brake of an automobile. The elimination of the handbrake lever permits the vehicle interior to be redesigned, and functions can now be realized that were formerly known only in vehicles with an automatic transmission. For example, with an electromechanical parking brake it is possible to stop a vehicle on a hillside and to guarantee that the handbrake will automatically disengage when the car starts up again, e.g., on the hill.

The braking force is produced by a component group within the engine and is transmitted to a spindle drive consisting of a spindle nut and a spindle. A tractive force is transmitted from the spindle to a cable pull, which is connected to the actual braking device. To connect the cable pull to the spindle, it is known to secure the cable pull to the spindle in an undetachable manner. This has a disadvantage in that the entire unit, consisting of spindle and cable pull, must be replaced if a tear occurs in the cable.

In an improved variant, a bowl-shaped fitting is provided on the end of the cable pull that is assigned to the spindle, such that the free end of the spindle can be inserted into this bowl-shaped fitting. To protect the spindle from twisting, a projection is provided inside of the bowl-shaped fitting, and this projection engages with a recess on the free end of the spindle. The advantage of this variant is that the complete unit consisting of spindle and cable pull does not have to be replaced if the cord is torn; it suffices to replace the torn cord alone. A disadvantage is that the cable pull has a very elaborate design due to the special form of the fitting. The use of standard cable pulls with conventional fittings is not possible.

The aim of the invention is to propose a spindle to which a standard cable pull and fitting can be attached in a removable manner.

It is also the aim of the invention to specify a connecting method, by means of which a load-bearing connection between two structural parts can be produced in a simple fashion.

The device-specific aim is achieved in a spindle exhibiting the features of patent claim 1. The process-specific aim is achieved with the features of patent claim 16.

Advantageous elaborations of the spindle and the connecting method are indicated in the secondary claims.

In accordance with the invention, a coupling part is fastened to the free end of the spindle in a removable manner. The coupling part has at least two segments, specifically a receiving section, whose design makes it suitable for receiving a fitting that belongs to a cable pull, and a fastening section, by means of which the coupling part is fastened to the free end of the spindle. In accordance with the invention, the fastening section is compressed (crimped) together the free terminal section of the spindle. One advantage of the invention is that it permits the use of conventional cable pulls with an enlarged area (a fitting) at their end. The manufacturing and repair costs are consequently reduced. Because of the detachable fastening method it is possible to replace the cable pull in a simple manner in the case of damage.

In order to permit the transmission of maximal forces from the spindle to the cable pull, means for receiving an axial component of force are advantageously provided on the free terminal section of the spindle. These means are designed so that the shape of the terminal area of the spindle differs from that of a smooth cylinder. To this end, the terminal section of the spindle can take the form of, e.g., a thread. It is important that the fastening section of the coupling part rests against the body of the terminal section during crimping, so that a form-fit is achieved.

In the crimping process it is especially advantageous if the fastening section is surrounded by an additional jacket, which is crimped along with the fastening section, with the result that at least three components are crimped—the jacket, the fastening section, and the terminal section of the spindle. The provision of the jacket prevents the further enlargement of the fastening section of the coupling part. Ideally the jacket will be made of steel. Crimping is performed from the outside, by the application of force in the radial direction, using, e.g., six pressure plates distributed over the circumference.

The invention design advantageously provides that the coupling part is a flexible punching, ideally of one piece, such that the fastening section is formed by two partial shells that face each other and are of identical shape.

In disassembled condition the jacket formed by the partial shells is not closed all the way around; rather, the partial shells are separated from each other by a slot to make it easier to slide them on to the free terminal section of the spindle.

A recess for introducing the cable pull is provided in the front wall of the receiving section of the coupling part—more specially, in the front wall facing away from the spindle. The recess is so designed that the cable pull can be introduced in a direction radial to the pulling direction.

In order to center the cable pull in the receiving section, projections bent in the direction of the spindle are provided on either side of the receiving section. The projections are so dimensioned and designed that the steel cord comes to rests on the hypothetical longitudinal central axis of the spindle. Forces working in the radial direction, and thus tipping effects, are thereby advantageously avoided. The fitting of the cable pull rests against the inside of the end wall of the receiving section, in the rim area of the recess.

To prevent the spindle from twisting, an anti-twist safeguard is provided, which can be connected in torque-proof fashion to the coupling part. The anti-twist safeguard interacts with the housing of the spindle drive and thus forms a torque support. The anti-twist safeguard is advantageously designed as an oval part that is made of plastic and can be slid or pushed onto of the coupling part, where it rests against a stop.

In the connecting process according to the invention, an initial component—e.g., a flexible punched part as described above—is positioned in such a way that it encompasses a second component—e.g., a spindle. This is made possible, e.g., in that the first component, with its fastening section (ideally jacket-shaped), is slid or pushed over the second component. Furthermore, at least one jacket is provided which is positioned so that it at least partially encompasses the fastening section of the first component. In the case of one jacket this can be achieved by sliding the jacket onto the fastening section of the first component before the first component is slid onto the second component. After the jacket is thus positioned, a force is exerted externally on the jacket in the radial direction, so that the jacket, fastening section, and second component are crimped together and are thus connected to each other in an undetachable manner.

This is explained in greater detail on the basis of the drawing, which depicts an exemplary embodiment of the invention.

Shown are:

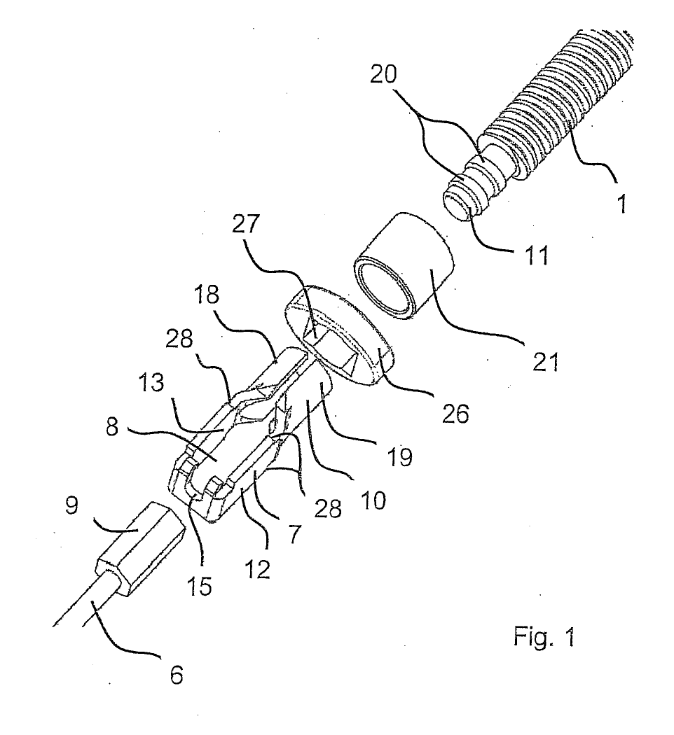

FIG. 1 an exploded view of the spindle, with the fastening section

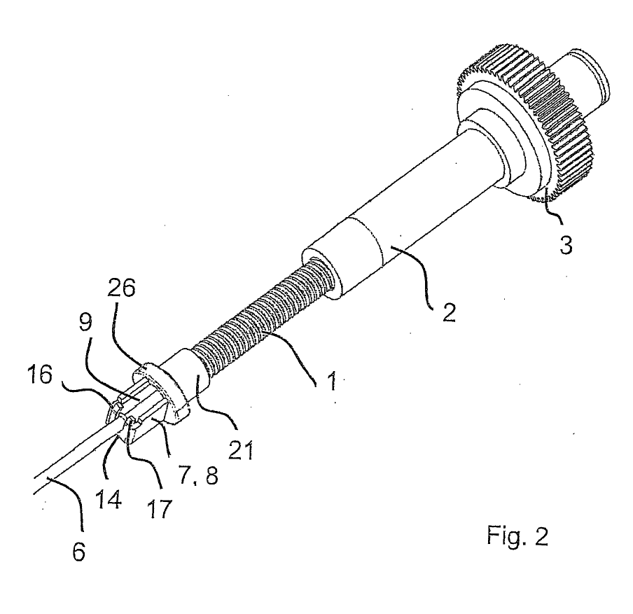

FIG. 2 a spindle, with the coupling part and cable pull assembled

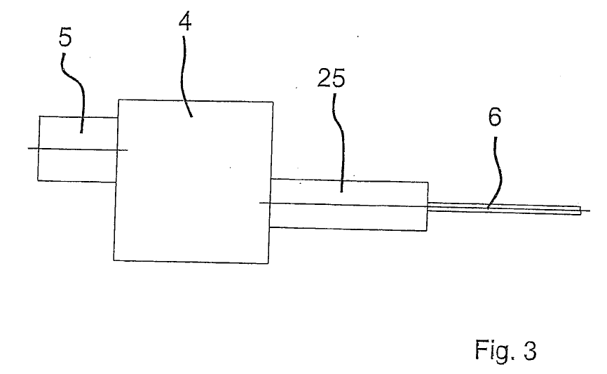

FIG. 3 a schematic depiction of the actuating device of a parking brake

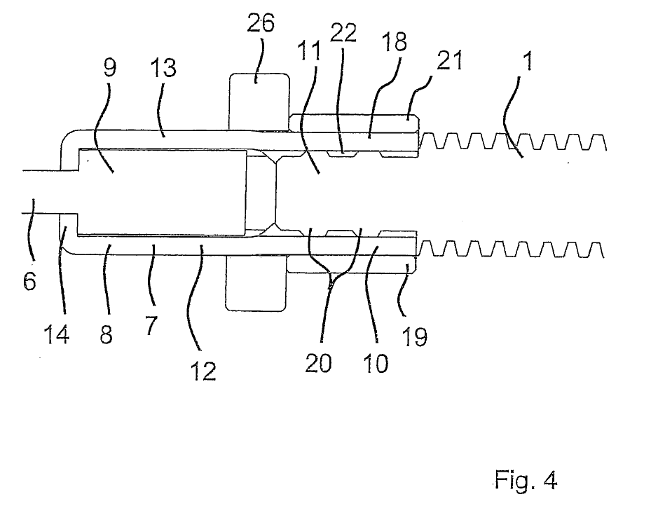

FIG. 4 spindle and coupling device (not yet crimped)

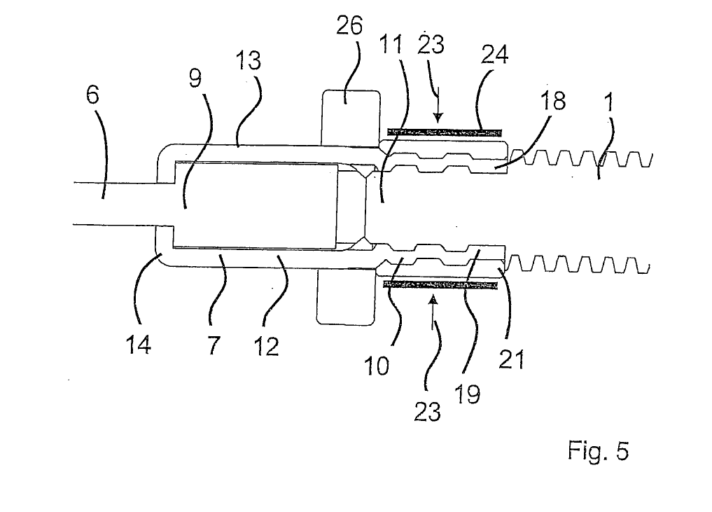

FIG. 5 spindle and coupling device (crimped)

The spindle 1 is a threaded spindle, which engages with a driven spindle nut 2. The spindle nut 2 is made of metal and has a sprayed-on gearwheel 3, which is part of a gear 4 and is in effective connection with an electromotor 5.

A cable pull (Bowden pull) 6 is provided in order to transmit axial forces from the spindle 1 to a braking device (which is not shown). The cable pull 6 is detachably connected to a coupling part 7 permanently connected to the spindle 1. The coupling part 7 is designed as a flexible punching and has a receiving section 8 for receiving the fitting 9 that is located at the end of the cable pull 6; the coupling part 7 also has a fastening section 10, which is crimped together with the free terminal section 11 of the spindle 1 by radial compression. The fitting 9 of the cable pull 6, which in this embodiment has a hexagonal cross-section, is received in the receiving section 8. The receiving section 8 basically consists of two opposing, parallel side walls 12, 13, which encompass the fitting laterally and without much play. A front wall 14 connects the two side walls 12, 13, on the side facing away from the spindle 1. Provided in the front wall 14 of the receiving section 8 is a slotted recess 15, which is open toward one side in order to permit the fitting 9 to be moved into the receiving section 8. The fitting 9 is centered in the receiving section 8, so that the cable pull 6 and the hypothetical longitudinal center axis (not depicted) of the spindle 1 are in alignment, thereby preventing the occurrence of non-axial forces. To this end, the length of the recess 15 is such that the cable pull comes to lie in an appropriately centered position. Lateral movement of the cable pull is prevented by the side walls 12, 13 of the receiving section 15, which rest against the cable pull. Provided at the upper end of one side of the recess 15 are two projections 16, 17, which are bent in the direction of the spindle 1 and thereby prevent the fitting 9 from moving, and thus prevent the cable pull 6 from leaving the recess 15. As a result, the fitting 9, and along with it the cable pull 6, are centered in the indicated optimal position. With its side facing the cable pull 6 the fitting 9 rests against the inside of the front wall 14.

As already explained, the projections 16, 17 prevent the fitting 9 from sliding out of the receiving section 8, which is open on two sides. Inserting and removing the fitting 9 into and from the receiving section 8 is only possible when the cable pull 6 is in relaxed condition. In the process, the fitting 9 is inserted into the receiving section from a slightly inclined position and the cable pull 6 comes to rest in the recess 15. Here it is important that the receiving section 8 is longer than the fitting 9.

As it moves toward the spindle 1, the receiving section 8 passes into the jacket-like fastening section 10, which consists of two facing shells 18, 19. The inner diameter of the fastening section 10 is such that upon assembly the fastening section 10 can be slipped onto the free terminal section 11 of the spindle before the crimping process takes place. The free terminal section 11 of the spindle 1 has a structured design in order to improve the firmness of connection between the coupling part and the spindle 1. In the given exemplary embodiment, the structure is determined by two axially spaced rings 20 that are elevated in the radial direction.

Surrounding the jacket-shaped fastening section 10 of the coupling part 7 is a steel jacket 21, which was first slipped onto the shells 18, 19. Through the effect of radial force distributed over its circumference, the jacket 21 is crimped together with the fastening section 10, and the latter is thus crimped together with the free terminal section 11 of the spindle 1. In the crimping process the material of the fastening section 10 flows into the cavity 22 between the rings 20 and thereby produces a form-fit. The jacket 21 also conforms to this structure. The rings 20 provide a means for improving the reception of axial force, with the result that the connection between the coupling part 7 and the spindle 1 is substantially firmer. A further improvement in the connection is provided by the jacket 21, which prevents the re-expansion of the coupling part 7, which is a flexible punching. In FIG. 5 the arrows 23 schematically indicate the radial compression force exerted by the crimping tool 24.

To prevent the spindle 1 from twisting around the longitudinal central axis inside the spindle housing 25, an anti-twist safeguard 26 made of plastic is provided. The anti-twist safeguard 26 is oval in contour and interacts with a recess (not shown) in the spindle housing 25. The anti-twist safeguard 26 is connected to the coupling part 7 in torque-proof fashion. To this end the anti-twist safeguard 26 has a central through-hole 27, by means of which it can be slipped onto the coupling part 7 before the jacket 21 is mounted. Four contact edges 28 are provided in order to limit the degree to which the anti-twist safeguard 26 can be mounted onto the coupling part 7.

In the connecting process specified by the invention the jacket 21 is first slipped onto the fastening section 10 of a first component (coupling part 7), whereupon the first component (coupling part 7), including the fastening section 10, is slipped onto the second component (free end 11 of the spindle 1). The force exerted on the jacket in the radial direction then takes effect, so that the jacket 21 is crimped together with the fastening section 10 and the second component. The connection can be substantially improved by providing means 20 on the second component for improving the reception of axial force; with these means 20 the fastening section 10 creates a form-fit after crimping.

### LIST OF REFERENCE NUMERALS

1 spindle
2 spindle nut
3 gearwheel
4 gear
5 electromotor
6 cable pull
7 coupling part
8 receiving section
9 fitting
10 fastening section
11 free terminal section
12 lateral wall
13 lateral wall
14 front wall
15 recess
16 projection
17 projection
18 shell
19 shell
20 rings
21 jacket
22 cavity
23 radial force
24 crimping tool
25 spindle housing
26 anti-twist safeguard
27 through-hole
28 contact edge

1. Spindle, particularly as a component of the spindle drive in an electromechanical parking brake of an automobile,
wherein
a coupling part (7), with a receiving section (8) for receiving a fitting (9) that belongs to a cable pull (6) and with a fastening section (10), is provided on the free terminal section (11) of the spindle (1), such that the fastening section (10) of the coupling part (7) is crimped together with the free terminal section (11) of the spindle (1).

2. Spindle according to claim 1,
wherein
means (20) for receiving an axial force are provided on the free terminal section (11) of the spindle (1).

3. Spindle according to claim 2,
wherein
a process of crimping connects the fastening section (10) in a form-fitting manner to the means (20) for receiving an axial force.

4. Spindle according to claim 2,
wherein
the means (20) take the form of a radial cavity and/or elevation and/or profiling and/or threaded section.

5. Spindle according to claim 1, wherein
the coupling part (7) takes the form of a flexible punching, ideally one comprising a single piece.

6. Spindle according to claim 1, wherein
the receiving section (8) is open on at least one side, and ideally on two, opposite sides.

7. Spindle according to claim 1, wherein
the fastening section (10) takes the form of a jacket.

8. Spindle according to claim 6,
wherein
the fastening section (10) is formed by at least two shells (18, 19), which ideally are of identical shape.

9. Spindle according to claim 1, wherein
a jacket (21), preferably of steel, is provided, which at least partially encompasses the fastening section (10) of the coupling part (9) and which is crimped together with the fastening section (10).

10. Spindle according to claim 1, wherein
the side (14) of the receiving section (8) that faces away from the spindle (10) has a recess (15), ideally in the form of a slot, for introducing the cable pull (6).

11. Spindle according to claim 1, wherein
means (16, 17) are provided for centering the fitting (9) in the receiving section (8).

12. Spindle according to claim 1, wherein
means (16, 17) are provided to prevent the fitting (9) from falling out of the receiving section (8).

13. Spindle according to claim 8,
wherein
the means (16, 17) for centering the fitting (9), or for preventing its dislocation, are provided in the form of a projection, which is positioned on either side of the recess and ideally is bent in the direction of the spindle.

14. Spindle according to claim 1, wherein
an anti-twist safeguard (26) is provided for the spindle (1).

15. Spindle according to claim 1, wherein
the anti-twist safeguard (26) is provided in the form of a non-circular component which is ideally plastic in material and oval in cross-section and which is connected in a torque-proof manner to the coupling part (7), preferably in such a way that it can be slipped onto said coupling part (7).

16. Process for permanently connecting an initial component, ideally a flexible punching, to a second component, ideally a rotating part, particularly a spindle, according to claim 1, wherein
the first component is positioned so that, using its fastening section (10), which is ideally jacket-shaped, said first component at least partially encompasses the second component, and at least one jacket (21) is provided, which is positioned so as to at least partially encompass the fastening section (10) of the first component, and the jacket (21) is thereafter crimped radially in the direction of the second component.

17. Connecting process according to claim 16,
wherein
means (20) for receiving an axial component of force are provided on the second component.

18. Connecting process according to claim 17,
wherein
a crimping process connects the fastening section (10) in a form-fitting manner to the means (20) for receiving an axial force.

19. Connecting process according to claim 17,
wherein
the means (20) take the form of a radial cavity and/or elevation and/or profiling and/or threaded section.

20. Connecting process according to claim 18,
wherein
the means (20) take the form of a radial cavity and/or elevation and/or profiling and/or threaded section.
